(19) United States
(12) Patent Application Publication
(10) Pub. No.: US 2002/0007256 A1
(43) Pub. Date: Jan. 17, 2002

(54) Analyzing method and system for measured data

(76) Inventor: Hirohumi Takiue, Tokyo (JP)

Correspondence Address: McGinn & Gibb, PLLC, 8321 Old Courthouse Road, Suite 200, Vienna, VA, 22182-3817, US

(21) Appl. No.: 09/871,994

(22) Filed: Jun. 4, 2001

(30) Foreign Application Priority Data
Jun. 5, 2000 (JP) 167356/2000

(51) Int. Cl. G06F 11/00; G06F 15/00

(52) U.S. Cl. 702/188

(57) ABSTRACT

A measuring instrument in a user side connects directly with an analyzing center receiving measured data and sending setting designations for measuring again in the measuring instrument. Further, a specialist of the center staff can attend the measured data. Accordingly, the center staff can analyze the measured data and control remotely by means of sending the setting designation for measuring for complicated measured data if necessary.

### BACKGROUND OF THE INVENTION

The present invention is related to an analyzing method and system for measured data, where the measured data are obtained by an instrument belonging to a user, sent to an analyzing center, analyzed by an analyzer in the analyzing center, and sent back to the user. The user accesses the analyzing center through communication networks by a communication terminal and sends the measured data of an object measured by an instrument belonging to the user. The analyzing center analyzes the measured data sent from the user and sends results obtained by the analyzing back to the user. Specially, this analyzing method and system is possible to analyze such measured data as the analyzer might not analyze.

As an existing analyzing system for measured data, a frequency analyzing system is disclosed, for example, in Japanese Unexamined Patent Application (JP-A) No. H. 10-206149.

FIG. 1 shows a frequency analyzing system as an existing analyzing system for measured data.

Referring to FIG. 1, this frequency analyzing system comprises a measuring equipment 101, a communication terminal unit 102, a server 103, and networks 104.

The measuring equipment 101 sends measured data giving a roughness of a processed surface of an object to a server 103 for analyzing. The communication terminal unit 102 of user is connected to the server 103 through networks 104 by a browser therein, directs an analysis to the server 103, and displays an analysis result sent from the server 103 on a screen of panel. The server 103 stores the measured data giving a roughness of a processed surface of the object, which have been input from the measuring equipment 101. Then the server 103 analyzes the stored data at a receipt of the analysis direction from the browser of the terminal unit 102 and sends analysis results back to the terminal unit 102.

The above-described existing analyzing system has following problems.

The first one is no countermeasure in case that the analysis of the measured data sent from the user is impossible in the data analyzer. For example of the above JP-A publication, the analyzer needs to store previously such information as measurement results and various basic process conditions for analyzing, and refers the information at the analysis. However, the reference information has a limit and includes mainly past data and information. Accordingly, it occurs much often that analysis is impossible.

The second one is difficulty of quick amendments in case of occurrence of wrong result for analyzing. The reason is that, in case of receipt of the wrong results for analyzing, it is rare that a professional to be able to resolve the results exists and it needs that user calls the professional from some other place, in the user's side.

### SUMMARY OF THE INVENTION

It is therefore an object of the present invention to provide an analyzing method and system for measured data, which are capable of dealing effectively with analysis being impossible and quickly with some wrong result for analyzing.

According to the present invention, there is provided a method analyzing data in a center, wherein the data is obtained from an instrument measuring an object in a user and sent through a communication network to the center for analyzing, comprising the steps as follows.

One of steps is accessing directly through the communication network to the center from the instrument. Another one is sending the measured data together with a required information from the instrument to the center. Another one is analyzing the measured data in the center. Another one is sending back an analysis result from the center to the user.

As a result, it is possible to achieve that the data are transferred directly between the center for analyzing and the instrument in user. Accordingly, the analyzing center can absorb directly and collect repeatedly the measured data from the instrument.

The above communication network may be an INTERNET and the center has a homepage on the INTERNET. The additional steps are accessing and opening the homepage from the user at a request for the analysis of the measured data, inputting data into required items shown on the homepage in the user, and sending the input data from the user to the center.

The above-described center may station at least one center staff of professional who can analyze the measured data. The additional steps are analyzing the measured data automatically according to reference data stored previously, and further asking the center staff to come for impossibility of the automatic analysis,

The center staff can access the instrument, control the instrument by setting data for measuring sent from the center, and the center receives measured data for analyzing again.

As a result, it is possible that the center staff controls remotely measuring of the instrument, collects again correct measured data, and discovers any wrong operation of the instrument or any wrong measuring method.

According to the present invention, there is provided a system analyzing data in a center, wherein the data is obtained from an instrument measuring an object in a user and sent through a communication network to the center, and the instrument and the center further comprising followings.

The instrument directly connects to the communication network, accesses the center through the communication network, sends the measured data, and, in case of receiving setting data from the center, measures the object and sends the measured data again, and receives analysis result from the center. And the center analyzes the measured data received from the instrument, sends back a setting data to the instrument in case of impossibility of analysis for the measured data, and sends an analysis result to the user.

### BRIEF DESCRIPTION OF THE DRAWINGS

FIG. 1 is a block diagram showing an existing analysis system for measured data,

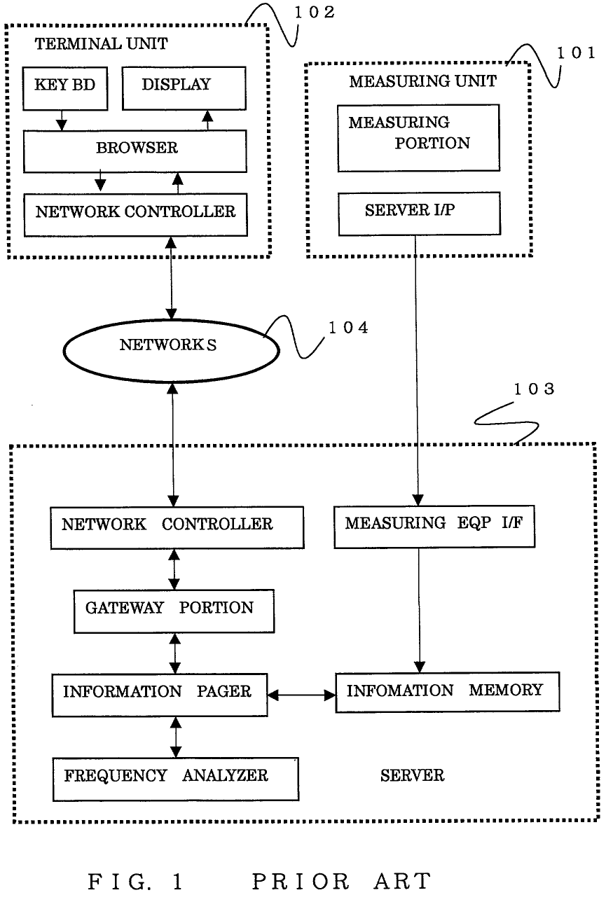

FIG. 2 is a block diagram showing an embodiment of an analysis system for measured data in this invention,

FIG. 3 is a flowchart showing a collection process for measured data in user side illustrated in FIG. 2,

FIG. 4 is a flowchart showing an analysis request process in user side illustrated in FIG. 2,

FIG. 5 is a flowchart showing a reception process for analysis request in administration center side illustrated in FIG. 2, and

FIG. 6 is a flowchart showing a reception process in measured-data process center side illustrated in FIG. 2.

### DESCRIPTION OF THE PREFERRED EMBODIMENTS

Now, a preferred embodiment of the present invention will be described with reference to the drawings.

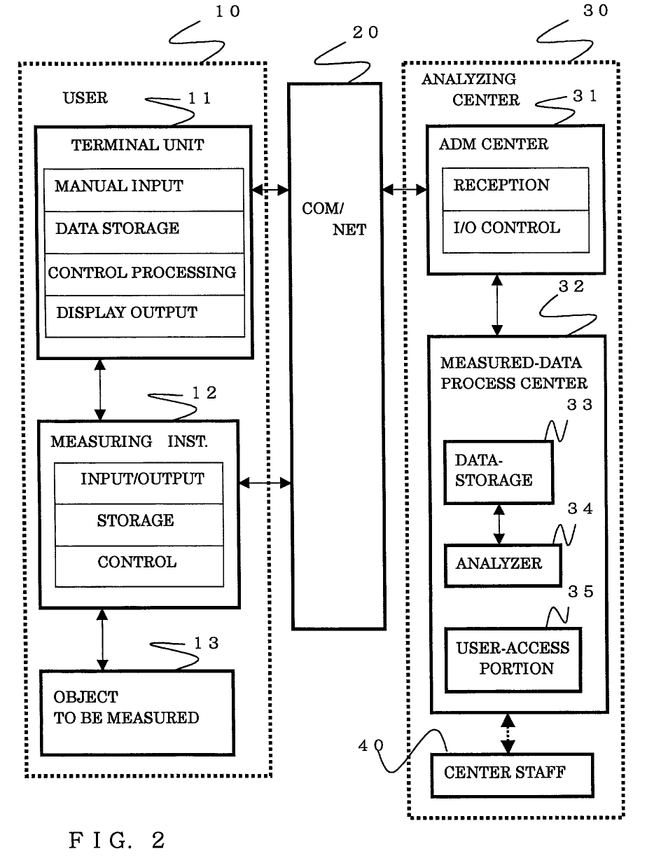

FIG. 2 is a functional block diagram of the embodiment of an analyzing method for measured data in this invention.

Referring to FIG. 2, an analyzing system for measured data comprises a user 10 and an analyzing center 30 connected each other through communication networks 20. The user 10 is inter-working through to an analyzing center 30 and the analyzing center 30 makes a center staff 40 station therein. The communication networks 20 may connect a plurality of users 10 and a plurality of analyzing centers 30. The user 10 and the analyzing center 30 are connected with the communication networks 20 by a subscriber line or a leased circuit respectively. The communication networks 20 might be composed of any one or combined one of public telephone networks and data networks and an INTERNET.

The user 10 is a user who requests analysis of some measured data and comprises a terminal unit 11, a measuring instrument 12, an object 13 to be measured, each of which may be composed by a plurality thereof. In the user 10, the terminal unit 11 sends measured data of the object 13 measured by the measuring instrument 12 to the analyzing center 30 by an analysis request and then receives an analysis result.

The analyzing center 30 comprises an administration center 31 and a measured-data process center 32. A plurality of the administration centers 31 or the measured-data process centers 32 may be comprised in the analyzing center 30.

In side of the user 10, the terminal unit 11 is such a data processing device as a personal computer for example, and connects with a measuring instrument 12 on one hand and directly with the communication networks 20 on the other hand. The terminal unit 11 comprises a manual input means, a data storage means, a control processing means, and a display output means. The manual input means receives data input manually from the user. The control processing means deals with control of the terminal unit 11 and communication between the communication networks 20. The display output means outputs data or information by voice, screen display, printing, and/or the like.

The measuring instrument 12 is an oscilloscope, for example, which measures an electric waveform, voltage, and the like of an object to be measured and connecting therewith. The measuring instrument 12 comprises an input/output means, a storage means, and a control means. The input/output means connects with the terminal unit 11 for control of the measuring instrument 12 and sends and receives data and information between the communication networks 20 connecting therewith. The storage means stores measured data, received information, and the like. The control means controls the object to be measured and collects measuring data.

In the analyzing center 30, the administration center 31 connects between the communication networks 20 on one side and the measured-data process center 32 on the other side and comprises a reception means and an input/output control means. The reception means receives requests from the user 10 and the input/output control means sends and receives data and information to and from the user 10.

The measured-data process center 32 comprises a data-storage 33, an analyzer 34, a user-access portion 35. The data storage 33 stores previously reference data in order to analyze the measured data. The analyzer 34 analyzes the measured data received from the user 10 by referring data of the data storage 33. The user-access portion 35 receives data input from the center staff 40 on one hand, and interfaces with the user 10 according to control of the center staff 40, connecting to the user 10 through the administration center 31 and the communication networks 20 on the other hand.

Consequently, the user 10 is possible to sends directly the measured data of the measuring instrument 12 into the analyzing center 30 through the communication networks 20 from the terminal unit 11 or the measuring instrument 12. That is, the user 10 can send the measured data absorbed from the measuring instrument 12 to the terminal unit 11. On the other hand, the analyzing center 30 can directly absorb the measured data from the measuring instrument 12 by request received from the terminal unit 11.

The administration center 31 adds information of the user to the measured data received from the user 11 and sends it to the measured-data process center 32. In case that the measured data received can be easily disposed by the measured-data process center 32, the analyzer 34 automatically analyzes the data and sends back to the administration center 31. In case of necessity of some complication dealing for analyzing data, the center staff 40 is asked to come to the analyzing center 30, and then analyzes the data and sends an analysis result of the data to the administration center 31. The administration center 31 sends out result data including the analysis result and so on to the user 10 through the communication networks 20.

Namely, one of different points from the existing one are that the center staff 40 is stationed all day or a normal work time zone in the analyzing center 30. And another one is that the measuring instrument 12 of the user 10 sends and receives data and information directly with the measured-data process center 32 of the analyzing center 30 through the communication networks 20. Accordingly, it is possible that the center staff 40 corresponds to the measured data being impossible to be analyzed by the analyzer 34. And the analyzer 34 can ask directly to the measuring instrument 12 of the user 10 through the user-access portion 35. Further, as shown as a combination by the above composition, it is possible that the center staff 40 operates and controls remotely the measuring instrument 12 according to the analysis result.

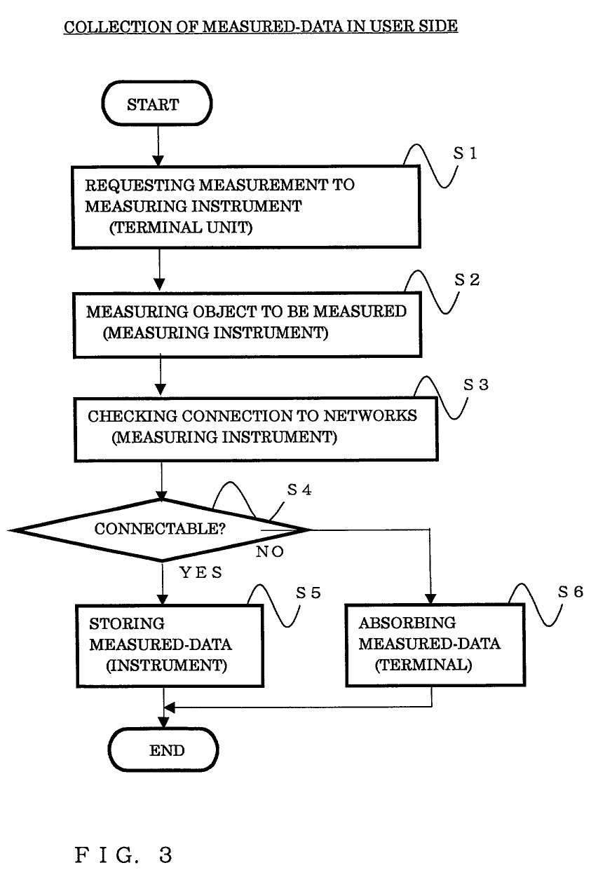

Referring to FIG. 2 and flowcharts in FIGS. 3 through 6, main procedure in FIG. 2 will be described as follows. Here the communication networks 20 is an INTERNET, and the terminal unit 11, the measuring instrument 12, and the administration center 31 directly connect with the INTERNET without dial-up connection. By this structure, any telephone number dialing is unnecessary for making connection because of no telephone network between the user 10 and the INTERNET of the communication networks.

At first, referring to FIGS. 2 and 3, description will be made of a procedure of a collection of the measuring data as follows, which is to be performed by the user 10 before his request of the analysis thereof.

In the user 10, the terminal unit 11 receives an input of a measuring request by analysis request of user and then requests a measurement to the measuring instrument 12 (Step 1). The measuring instrument 12 measures the object 13 according to direction from the terminal unit 11 (Step 2), and collects some measuring and related data thereof. The measuring instrument 12 further judges possibility of connection to the communication networks 20 thereby (Step 3).

In case being possible (Yes of Step 4), the measuring instrument 12 stores the measured data with the storage thereby (Step 5). In case being impossible (No of Step 4), the terminal unit 11 absorbs the measured data from the measuring instrument 12 and stores the measured data in the data storage (Step 6).

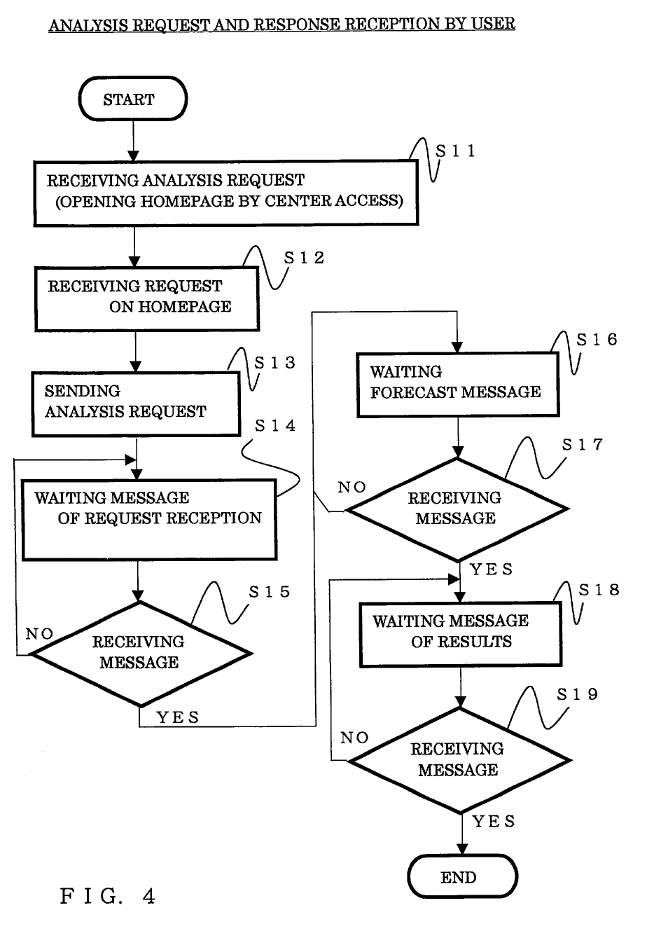

Referring to FIGS. 2 and 4, description will be made of a procedure of an analysis request and a response reception by the user 10 as follows. In this example, the analysis request makes use of a homepage on the INTERNET of the communication networks 20.

In case that the user 10 requests an analysis of the measured data to the analyzing center 30, the terminal unit 11 receives an analysis request from the user and then accesses to a homepage of the analyzing center 30, which is opened (Step 11).

The analysis request may be directly accessed the homepage by the measuring instrument 12 connecting directly with the communication networks 20. For example, the homepage includes items of required data and information to be sent from the user side and items of required data and information to be responded from the analyzing center 30.

The data and information include, for example, a title, a user ID, a password, a user file name, a center file name, a measured data format, a circuit diagram file name, a circuit diagram format, an output element, an output element specification, an input element, an input element specification, automatic analyzing items, the other analyzing items, a contact method at end of the analysis, an appointed date of delivery, a receipt number, a receipt center name, a receipt date in center, a forecast due time of center, a forecast charge for analysis, a user remarks, and so on.

The terminal unit 11 receives inputs of the required items on the homepage and then receives a designation of a sending button on the homepage (Step 12). The data of the required items are sent as an analysis request to the analyzing center 30 (Step 13). At the analysis request, the predetermined important data are enciphered and then sent thereto. The analysis request can include the above data and information. Accordingly, it is possible that the measured data being an object of analysis on one hand or an absorption request instead of the measured data on the other hand are included in the analysis request. The absorption request is requesting to absorb the measured data from the measuring instrument 12 to the analyzing center 30.

Next, the terminal unit 11 is waiting a message of a request reception giving a reception notice of the analysis request (Step 14 and “No” of Step 15).

At “YES” of Step 15 or receiving of a request reception message, the terminal unit 11 is waiting a message of a forecast of time and cost required for this analyzing in the analysis center 30 (Step 16 and “No” of Step 17).

At “YES” of Step 17 or receiving of a forecast message, the terminal unit 11 is waiting a message of results of this analyzing in the analysis center 30 (Step 18 and “No” of Step 19).

At “YES” of Step 19 or receiving of a result message, the terminal unit 11 ends the steps for the analysis request.

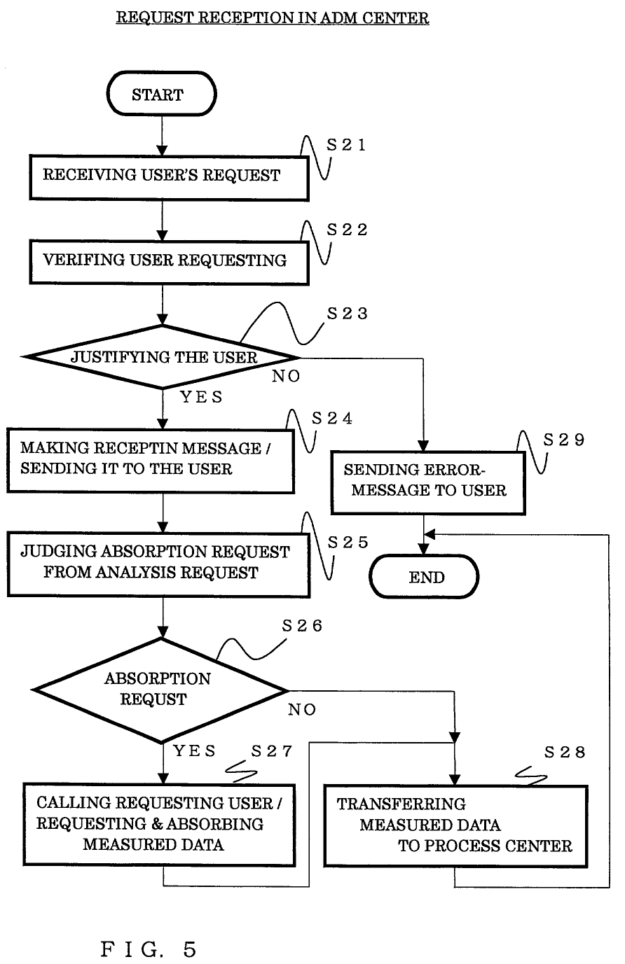

Referring to FIGS. 2 and 5, description will be made of a procedure of a reception of an analysis request from the user 10 in the administration center 31 as follows.

The administration center 31 is called from the user 10 through INTERNET of communication networks 20 and then opens a homepage. Next, the administration center 31 receives data including required items on the homepage by the analysis request of the measured data (Step 21). The administration center 31 verifies the justified user 10 according to a user ID and a password included in the received request (Step 22). In case of the verification of the justified user 10 (YES of Step 23), the administration center 31 makes and sends back a request reception message including a reception date, a reception number, and the like, as a notice of the reception of the analysis request (Step 24).

For example, in the request reception message as well as a forecast message and a result message described below, data are input in predetermined items on the homepage. The predetermined items include a title, a receipt number, a receipt center name, an analysis software name, an analyzing staff name, a contact address, analysis result file names and analysis result format for respective the center transmission and the user absorption, a required date by the user, a forecast due time in center, a sending date of the analysis result, a forecast charge for analysis, a center remarks, and the like.

Next, the administration center 31 judges the absorption request from the analysis request received (Step 25). In case of the absorption request (YES of Step 26), the administration center 31 calls the requesting user 10 and absorbs the enciphered data of the measured data and so on from the terminal unit 11 or the measuring instrument 12 (Step 27). Then, the administration center 31 transfers the data to the measured-data process center 32 (Step 28) and ends this procedure.

In case of “NO” in the above step 23 or not to be justified for the user 10, the administration center 31 sends an error message to this user 10 (Step 29).

In case of “NO” in the above step 26 or no absorption request, the procedure is advanced to the above step 28 directly and ends the steps.

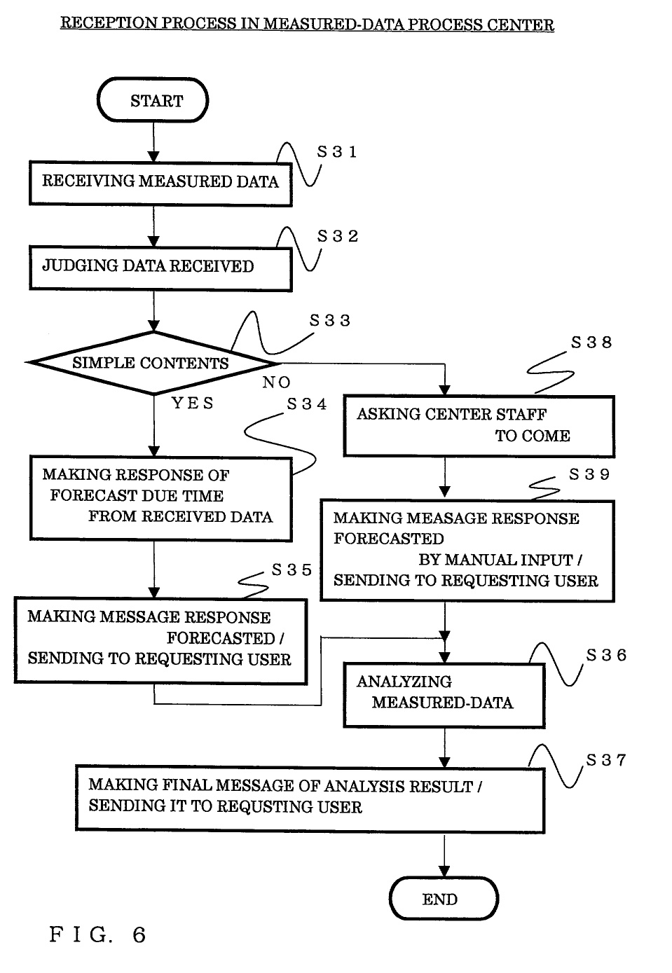

Referring to FIGS. 2 and 6, description will be made of a procedure of a reception of an analysis request from the user 10 in the measured-data process center 32 as follows.

The measured-data process center 32 receives the measured data and user data from the administration center 31 (Step 31). In the measured-data process center 32, the analyzer 34 judges the data received from contents thereof whether the analysis of the data is simple or not according to a predetermined standard (Step 32). In case of simple contents (YES of Step 33), the analyzer 34 forecasts the due time and the charge being necessary for the analysis, makes a response to the requesting user 10, and sends the response to the user-access portion 35 (Step 34). The user-access portion 35 makes a forecast message displayed on the homepage under the above response and sends the forecast message to the user 10 through the administration center 31 and the communication networks 20 (Step 35).

Next, the analyzer 34 analyzes the measured data (Step 36), stores the results of the analysis to the data-storage 33, and sends the results of the analysis to the user-access portion 35. The user-access portion 35 makes the analysis results into a final message and sends the final message to the requesting user 10 (Step 37). And then, the procedure is over.

In case that the above Step 33 is “NO” or the analyzer 34 can not analyze the received data being complicated in the contents, the analyzer 34 asks the center staff 40 to come (Step 38). The center staff 40 deals with this situation quickly. That is, the center staff 40 forecasts a due time and a charge being necessary for analysis from the data including measured data required for analysis and makes a response message to the requesting user 10.

The response message is made by manual input of the center staff 40 according to the above forecast on homepage displayed on the user-access portion 35 and sent to the requesting user 10 through the administration center 31 and the communication networks 20 (Step 39). This procedure is advanced to above-mentioned Step 36 but the center staff 40 being a professional or a specialist instead of the analyzer 34 performs the analysis. The center staff 40 also prepares the final message including the analysis result.

The analysis results of the measured data are transmitted by the method according to the contact method at an end of the analysis designated by the requesting user 10, together with such additional information as a receipt center name, an analyzer name, an analysis charge, and so on. For example, on the situation of center transmission and user automatic reception, the analysis result is sent to the terminal unit or the measuring instrument according to the user designation through the administration center and the communication networks.

On the other hand, on the situation of center transmission and user non-automatic reception, the analysis result is stored in a data-storage of the measured-data process center and sent to the designated position when the user becomes a situation being possible to receive the result.

In case of designation of user absorption, the final message may include only possibility of absorption of result data completed and a storing spot of the result data and may keep the data on storing until absorption of the requesting user.

Further, the user can select the stored data for reading. In this case, the data including analysis result are converted into a reduced form being visible on a display screen and the data of a large quantity itself is not sent. Such the data are keep in the analyzing center during certain periods.

Further, the screen of the homepage includes such items as a title, a receipt number, a user ID, a password, a question from user, and so on and has possibility of receiving an inquiry from the user. And the question and information from user is used for error of the sending data.

On the other hand, there is a case that the analyzing center side judges a problem of the data including the measured data received from user. In this case, the analyzing center can send the optimum values, being decided for the measuring instrument and the measuring method according to receiving instrument data, circuit data, and the like, to the user. In case of non clear situation, the analyzing center can question to the user through the communication networks according to such items as, for example, a title, a receipt number, a question from center, and so on displayed on the homepage. The user measures again by use of the optimum setting value sent from the analyzing center and then sends again the measured data to the analyzing center.

In the above description, the measuring instrument is an oscilloscope for example for measuring use of waveform, voltage, and so on. However, the measuring instrument may measure any other conditions. In the above embodiment, the communication network is the INTERNET. However, a normal telephone circuits can be used in the network also and can achieve the above object according to two-way transmission of data and information.

While the present invention has been described in detail in conjunction with the several preferred embodiments thereof, the present invention is not limited to the foregoing description but can be modified in various manners without departing from the scope of the invention set forth in appended claims.

As apparent from the foregoing description, according to the present invention, the measuring instrument connects directly with the analyzing center for transferring of the measured data and the designation for re-measuring to and from. Further, a professional of the center staff can attend the measured data. Accordingly, the center staff can analyze the measured data and control remotely by means of sending the designation for measuring for complicated measured data if necessary. This is possible to prepare for any impossible situation of automatic data analysis and respond quickly for any mistaken result of data analysis.

What is claimed is:

1. A method analyzing data in a center, wherein said data is obtained from an instrument measuring an object in a user and sent through a communication network to the center, comprising the steps of:
accessing directly through said communication network to said center from said instrument;
sending said measured data together with a required information from said instrument to said center;
analyzing said measured data in said center; and
sending back an analysis result from said center to said user.

2. A method analyzing data in a center according to claim 1, wherein said communication network is an INTERNET and said center has a homepage on the INTERNET, comprising the steps of:
accessing and opening the homepage from said user at a request for the analysis of the measured data;
inputting data into required items shown on the homepage in said user; and
sending the input data from said user to said center.

3. A method analyzing data in a center according to claim 1, wherein said center stations at least one center staff of professional, comprising the steps of:
analyzing the measured data automatically according to reference data stored previously; and further
asking the center staff to come for impossibility of the automatic analysis,
wherein the center staff analyzes the measured data.

4. A method analyzing data in a center according to claim 3, wherein said center staff accesses said instrument, controls said instrument by setting data for measuring sent from said center, and said center receives measured data for analyzing again.

5. A system analyzing data in a center, wherein said data is obtained from an instrument measuring an object in a user and sent through a communication network to said center, comprising:
said instrument further directly connecting to said communication network, accessing said center through said communication network, sending the measured data, and, in case of receiving setting data from said center, measuring the object and sending the measured data again, and receiving analysis result from said center; and
said center analyzing the measured data received from said instrument, sending back a setting data to said instrument in case of impossibility of analysis for the measured data, and sending an analysis result to said user.

6. A system analyzing data in a center according to claim 5, said center comprising:
an administration center accessing said user through said communication network, and receiving and sending data; and
a measured-data process center comprising:
a data storage storing previously reference data for analysis of the measured data;
an analyzer receiving the measured data through said administration center, analyzing the measured data according to the reference data, and sending an analysis result to said user through said administration center.

7. A system analyzing data in a center according to claim 6, wherein said center stations a center staff of a professional, said measured-date process center further comprising a user-access portion informing said center staff of the measured data in case of impossibility of the analysis, and then accessing said instrument, controlling said instrument, and receiving measured data again by operation of the center staff.
